(19) United States
(12) Patent Application Publication
(10) Pub. No.: US 2012/0141082 A1
(43) Pub. Date: Jun. 7, 2012

(54) BLADELESS OPTICAL FIBER CLEAVER

(76) Inventors: Joseph C. Sawicki, Austin, TX (US); Daniel J. Treadwell, Austin, TX (US); Donald K. Larson, Cedar Park, TX (US)

(21) Appl. No.: 13/388,902

(22) PCT Filed: Aug. 27, 2010
(86) PCT No.: PCT/US2010/046933

§ 371 Date: Feb. 3, 2012

Related U.S. Application Data
(60) Provisional application No. 61/237,829, filed on Aug. 28, 2009.

(51) Int. Cl. G02B 6/25

(52) U.S. Cl. 385/134

(57) ABSTRACT

An optical fiber cleaver to cleave an optical fiber is provided. The optical fiber cleaver comprises a generally planar main body and a generally planar flap portion movable with respect to the main body. The optical fiber cleaver also includes a first clamp disposed on the main body to receive and hold a first bare glass portion of the optical fiber and a second clamp disposed on the flap portion to receive and hold a second bare glass portion of the optical fiber. A shuttle device is disposed on the main body axially between the first clamp and the second clamp and is configured to move laterally with respect to an axis of the optical fiber. The shuttle device further includes a flexible abrasive material configured to contact the optical fiber and create a flaw on an outer surface thereof during cleaving.

### BACKGROUND OF THE INVENTION

1. Field of the Invention

The present invention is directed to an apparatus for cleaving an optical fiber, in particular, an optical fiber to be terminated in the field.

2. Background

In the area of optical telecommunication networks, it is often necessary to connect an optical fiber to another. Conventional connections include fusion splices, mechanical splices and plug/unplug-type connections. Oftentimes it is necessary to perform connections in a field environment. When making such connections in the field, it may be necessary to cut or cleave an optical fiber as part of the fiber preparation process.

Current portable optical fiber cleavers are expensive, precision mechanisms that typically include two main features. First, conventional cleavers have a mechanism for placing a controlled strain on the optical fiber, through tension, bending, torsion or a combination of tension, bending, and torsion. Second, conventional cleavers have a rigid blade, typically made from carbide or another hard material, for creating a flaw on the surface of the fiber. These blades can add significant cost and, in many cases, may require regular maintenance. Also, with a rigid blade, care must be taken not to damage the fiber as it is possible for the blade to impact the optical fiber with too much force. Some conventional fiber cleavers are described in U.S. Pat Nos. 6,634,079; 6,628,879; and 4,790,465. Another conventional cleaver is described in PCT Publication No. WO 2009/051918. Laser cleavers are also known and are utilized primarily in a factory or other controlled environment.

### SUMMARY

According to an exemplary aspect of the present invention, an optical fiber cleaver to cleave an optical fiber is provided. The optical fiber cleaver comprises a generally planar main body and a generally planar flap portion movable with respect to the main body. The optical fiber cleaver also includes a first clamp disposed on the main body to receive and hold a first bare glass portion of the optical fiber and a second clamp disposed on the flap portion to receive and hold a second bare glass portion of the optical fiber. A shuttle device is disposed on the main body axially between the first clamp and the second clamp and is configured to move laterally with respect to an axis of the optical fiber. The shuttle device further includes a flexible abrasive material configured to contact the optical fiber and create a flaw on an outer surface thereof during cleaving. In addition, at least one of the first and second clamps is configured to hold the second bare glass portion of the optical fiber with substantially no twisting force applied to the optical fiber.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIG. 1A is an isometric view of an optical fiber cleaver according to an aspect of the invention.

FIG. 1B is another isometric view of a fiber cleaver according to an aspect of the invention.

FIG. 1C is a bottom view of a fiber cleaver according to an aspect of the invention.

FIG. 2A is an isometric view of an exemplary shuttle device to an aspect of the invention.

FIG. 2B is another isometric view of an exemplary shuttle device to an aspect of the invention.

FIG. 3A is a side view of an exemplary fiber cleaver prior to cleaving of an optical fiber according to an aspect of the invention.

FIG. 3B is a side view of an exemplary fiber cleaver after cleaving of the optical fiber according to an aspect of the invention.

FIG. 4 is an isometric view of another fiber cleaver according to an alternative aspect of the invention.

FIG. 5A is an isometric view of another fiber cleaver according to an alternative aspect of the invention.

FIG. 5B is a cross section view of the exemplary shuttle device of the fiber cleaver of FIG. 5A.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention is directed to a bladeless apparatus for cleaving an optical fiber in a simple and inexpensive manner that is suitable for field operations. The cleaver embodiments described herein can be utilized with field terminable connectors or fusion splice devices. In particular, the cleaver embodiments herein utilize an anti-twist clamping system to reduce fiber twisting or torque during the clamping and cleaving process. An uncontrolled twisted fiber can lead to inconsistent cleaving results.

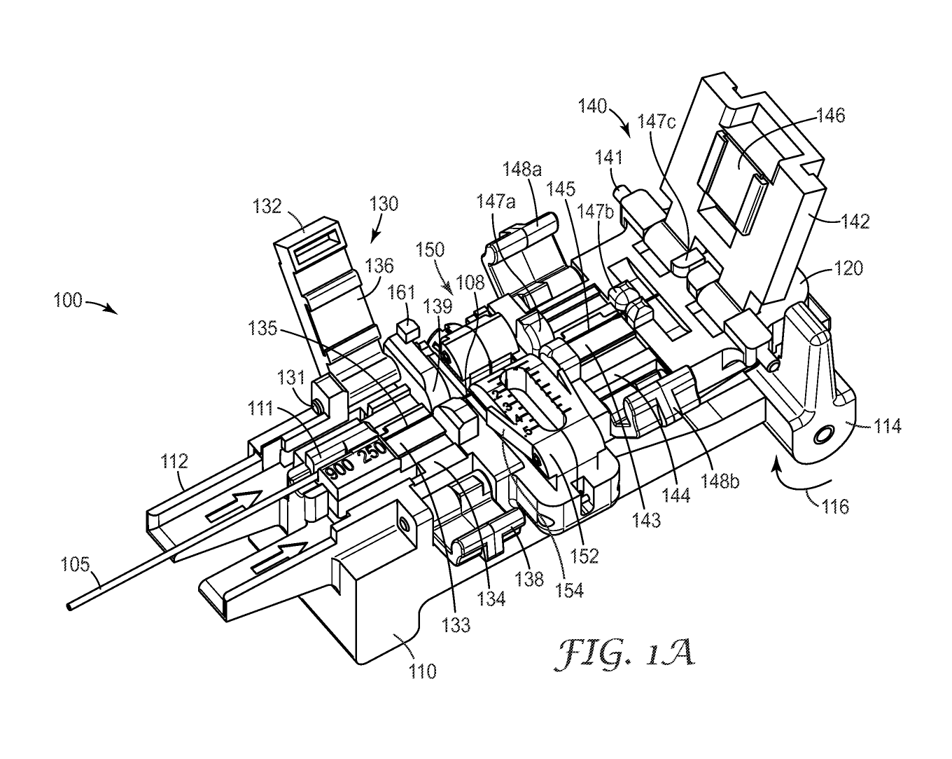

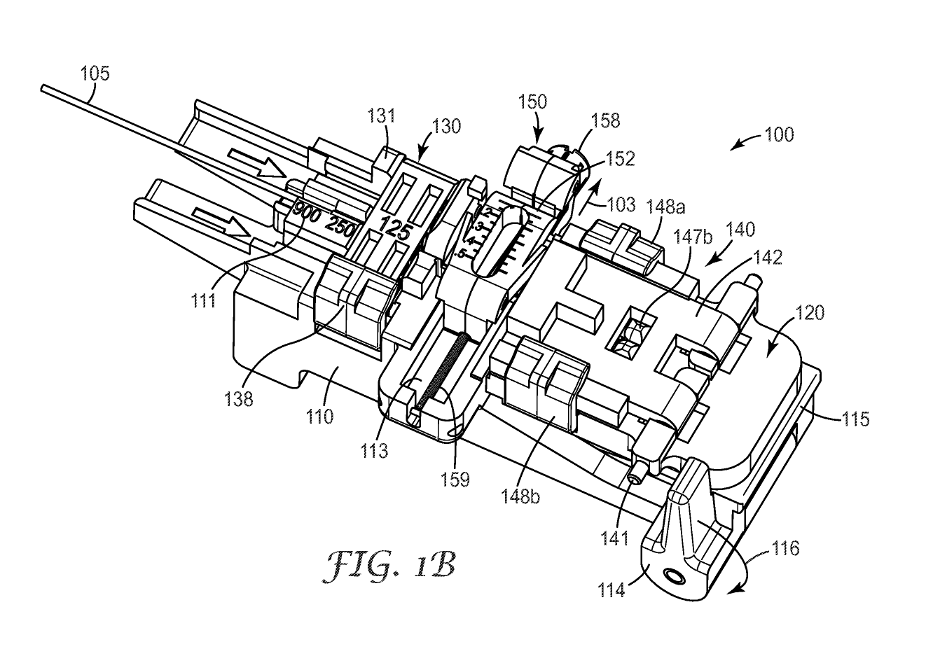

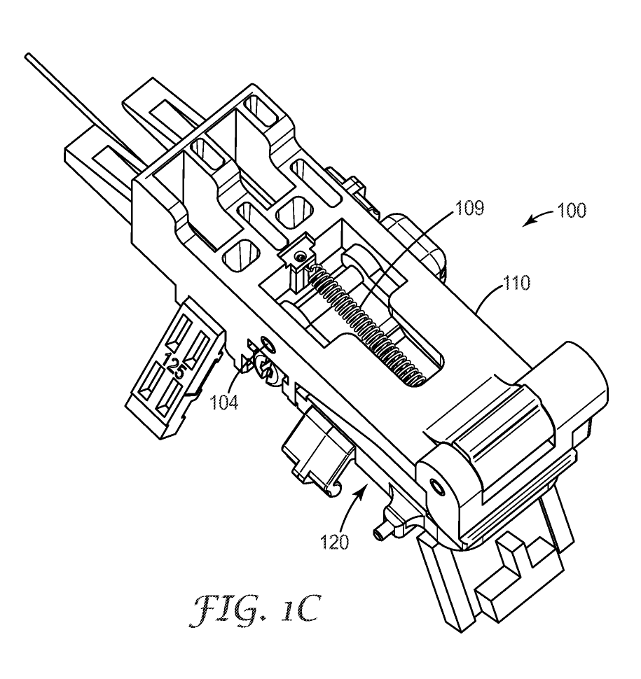

Exemplary optical fiber cleaver device 100 and components thereof are shown in FIGS. 1A-1C. Device 100 is a bladeless, portable fiber cleaving device that provides suitable tension to permit cleaving of a conventional optical fiber 105 through use of an abrasive material, such as a particle-coated filament, as opposed to a blade. Fiber cleaver 100 includes a generally planar main body 110 coupled to a generally planar, movable flap portion 120. Main body 110 and flap portion 120 are not required to be perfectly planar. The main body 110 and movable flap portion 120 can be movably coupled to each other, such as pivotably coupled or slidingly coupled. In the exemplary aspect of FIG. 1C, for example, a shaft 104 can be provided for movement of flap portion 120 relative to main body 110. In a preferred aspect, planar main body 110 and flap portion 120, and components thereof, can be formed or molded from a polymer material, such as a plastic, although metal and other suitably rigid materials can also be utilized.

Device 100 further includes a first clamp 130 and a second clamp 140 to temporarily hold an optical fiber 105 in place prior to cleaving. FIG. 1A shows clamps 130 and 140 in their open positions, and FIG. 1B shows clamps 130 and 140 in their closed positions. A shuttle device 150 is disposed between the first and second clamps 130, 140. The shuttle device houses the abrasive material and is configured to slide laterally on the main body 110, in a direction substantially perpendicular to the fiber axis.

As shown in FIG. 1A, first clamp 130 is configured as a conventional plate-type clamp, having a movable (or upper) clamp plate 132 that is rotatable about shaft 131, which is aligned substantially parallel to the fiber axis. Plate 132 clamps onto bottom clamp plate 134, which is mounted onto or formed on main body 110. A latch 138 can be disposed on main body 110 opposite to shaft 131 and can be used to hold clamp 130 in a closed position during the cleaving process.

Clamp 130 is configured to clamp a stripped (bare) portion 108 of fiber 105. The stripped portion 108 comprises the bare glass portion, with core and cladding, of fiber 105. In this manner, clamp 130 includes a bottom clamp plate insert 133 which includes a V-shaped groove 135, and is disposed on bottom clamp plate 134. The V-shaped groove 135 is configured to receive the bare portion 108 of fiber 105 when the fiber is placed in clamp 130. The bottom clamp plate insert 133 interacts with an upper clamp plate insert 136 when the first clamp 130 is placed in the closed position so that the upper clamp plate insert 136 contacts and presses onto the bare fiber portion 108 received in groove 135. In a preferred aspect, clamp plate inserts 133 and 136 are formed from a ductile material, such as aluminum, which is a strong material, yet structurally weaker than the bare glass portion 108 of fiber 105. As described in more detail below, this preferred construction can help provide consistent cleave angle results. In alternative aspects, the clamp plate inserts 133 and 136 can be formed from materials such as plastic, rubber, and steel.

In an experiment, the investigators observed the relationship between cleave angle and clamping plate insert composition for a cleaving device having a structure similar to that of device 100. In an experiment utilizing four different clamp plate insert materials (aluminum, stainless steel, a combination of stainless steel and rubber, and plastic), the investigators observed (for sample sizes of 15 cleaves each) that aluminum clamp plate inserts provided more consistent substantially perpendicular cleave angles (0 degree cleaves +/−3.5 degrees) than the other materials. Stainless steel clamp plate inserts also provide fairly consistent results, but at non-zero cleave angles.

As shown in FIG. 1A, device 100 includes a second clamp 140 disposed on flap portion 120. The second clamp 140 is configured as a plate-type clamp, having a movable (or upper) clamp plate 142. Clamp plate 142 is configured to rotate about a shaft 141. Unlike the rotation of clamp plate 132, clamp plate 142 rotates about shaft 141 that is aligned substantially perpendicular to the fiber axis. Plate 142 clamps onto bottom clamp plate 144, which is mounted onto or formed on main body 110. This latch orientation helps reduce torsional stresses being placed on the fiber during the clamping process prior to cleaving. In addition, in a preferred aspect, providing a construction with zero clearance for the clamp plate 142 and shaft 141 can also reduce torsional stresses. A latch set 148a and 148b can be disposed on main body 110 on either side of clamp 140 and can be used to hold clamp 140 in a closed position during the cleaving process.

Clamp 140 is also configured to clamp a stripped (bare) portion 108 of fiber 105. In this manner, clamp 140 includes a bottom clamp plate insert 143 which includes a V-shaped groove 145 disposed on bottom clamp plate 144. The V-shaped groove 145 is configured to receive the bare portion 108 of fiber 105 when the fiber is placed in clamp 140. The bottom clamp plate insert 143 interacts with an upper clamp plate insert 146 when the second clamp 140 is placed in the closed position so that the upper clamp plate insert 146 contacts and presses onto the bare fiber portion 108 received in groove 145. In a preferred aspect, clamp plate inserts 143 and 146 are formed from a ductile material, such as aluminum, which is structurally weaker than the bare glass portion 108 of fiber 105. In alternative aspects, the clamp plate inserts 143 and 146 can be formed from materials such as plastic, rubber, and steel.

The combination of the first and second clamps 130, 140, in particular the use of ductile inserts to clamp the bare portion of the optical fiber during cleaving, provides an anti-twist clamping system that can reduce fiber twisting or torque during the clamping and cleaving process.

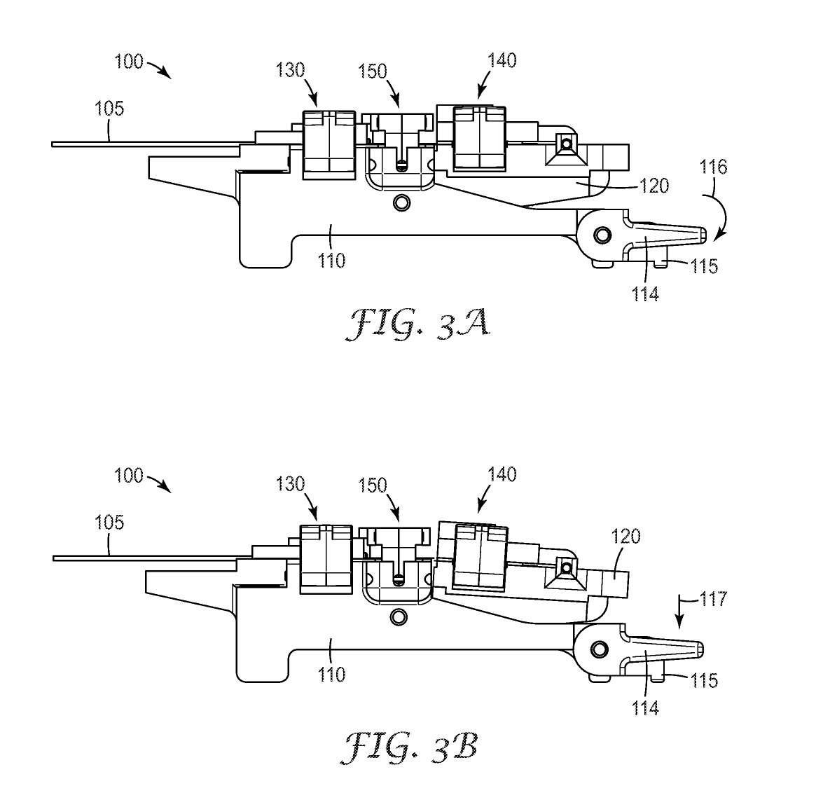

Device 100 can further include a movable member, such as lever 114, hingedly coupled to main body 110 at one end of the body. As shown in FIG. 1A, lever 114 is positioned in a pre-cleave position and engages flap portion 120 to keep it in a planar orientation with main body 110. As shown in FIG. 1B, lever 114 is coupled to support structure 115 that supports flap portion 120 prior to release of lever 114. When the lever 114 is released (see e.g., FIGS. 3A-3B), e.g., by rotating the lever 114 in the direction of arrow 116 shown in FIG. 1A, the lever/support disengages with body portion 120. Motion of flap portion 120 (e.g., downward in the direction of arrow 117 of FIG. 3B upon cleaving) can be accomplished substantially via internal spring tension—for example, an elastic element such as a spring, e.g., coil spring 109 (see FIG. 1C), can be coupled to body portion 110 and flap portion 120, pulling flap portion 120 downward relative to body portion 110. In an alternative aspect, a different type of spring can be utilized. The spring tension can be used to create a tension force of about 180 grams to about 280 grams. Note that the weight of the flap portion 120 (and any components formed or disposed thereon) can contribute to the tension force.

In a further alternative aspect, the device 100 can include interlock features, such as a ratchet to engage a portion clamp plate 142 to prevent the closing of clamp plate 142/clamp 140 when the flap portion 120 and hinge 114 are not placed in their pre-cleave positions. This configuration can help prevent improper insertion of the fiber to be cleaved. As mentioned above, device 100 further includes a shuttle device 150 disposed in a track 113 formed in the main body 110 (see FIG. 1B). Track 113 is formed so that shuttle device 150 travels laterally on the main body, substantially perpendicular to the axis of fiber 105. In a further aspect, a stop feature 161 (see FIG. 1A) can be provided on device 100 to interact with flange 154 to ensure that shuttle device 150 is not inadvertently removed from track 113 during or after a cleaving process.

The shuttle device 150 includes a body 152 that houses and holds an abrasive material used to introduce a flaw on the surface of fiber 105 during cleaving. In an exemplary aspect, the flaw may be introduced with a simple lateral movement of the abrasive material across the stripped fiber surface (e.g., in the direction of arrow 103). The flaw may be applied while the fiber is strained in a controlled manner or alternatively, the flaw may be applied before the fiber is strained.

In a preferred aspect, the abrasive material comprises a flexible abrasive material, such as a filament (e.g., a metal wire) having an abrasive material coated (either sparsely or densely) on an outer surface or portion thereof. The abrasive material can be a conventional abrasive mineral, such as diamond powders or particles, graphite/carbide powders or particles, or a similar material that is harder than glass. For example, in an exemplary alternative aspect, the flexible abrasive material can comprise a steel wire that is coated with diamond particles. In one example, the steel wire can have a diameter of about 140 μm, with diamond particles of about 20 μm in size. In other aspects, other sized wires can be utilized.

In another aspect, the flexible abrasive material can comprise a piece of a conventional sand paper sheet, or lapping film, having a grit of about 5 μm or greater. In a preferred aspect, device 100 provides a perpendicular cleave.

In other alternative aspects, the abrasive material can comprise a sheet or ribbon of sand paper, a sheet or ribbon of lapping film, or a string form abrasive.

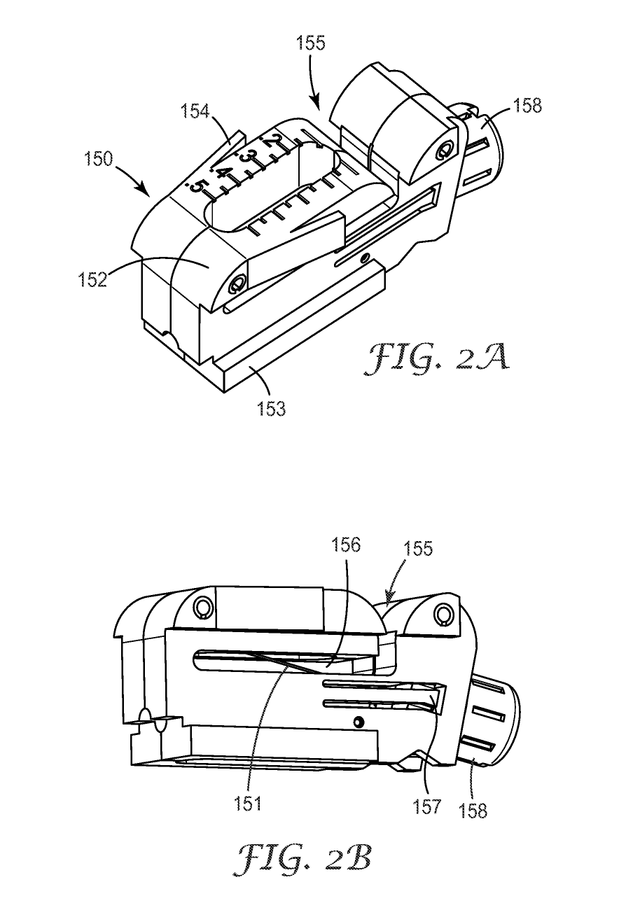

Referring back to FIGS. 2A and 2B, in a preferred aspect, the abrasive material comprises an abrasive material coated filament 151 (referred to herein as an abrasive coated wire 151 for short). In another aspect, the abrasive coated wire 151 is coupled to an adjustment mechanism 158 mounted on an outer surface of the shuttle. As shown in FIG. 2B, the adjustment mechanism can be shaped as a simple rotatable knob. Alternatively, the abrasive coated wire can be mounted within the shuttle by a fastener (not shown), such as a mechanical device or an adhesive. This configuration provides for the wire 151 to be supported on one end, leaving the other end free, thus allowing it to flex freely as it comes into contact with the optical fiber during cleaving. In addition, the adjustment mechanism allows the user to change the contact area of the abrasive coated wire once a particular area of the coated wire is worn after repeated use. In one aspect, a latch 157 (see FIG. 2B) can lightly engage adjustment mechanism 158 to hold the adjustment mechanism 158 in place to prevent inadvertent rotation. Latch 157 can also be configured to control the amount of angular displacement, for example, a 45° or a 90° displacement. In addition, the abrasive coated wire can be set at an initial contact angle such that applying the abrasive coated wire 151 at a particular angle can reduce unwanted torsional or shear forces on the optical fiber, which could detrimentally impact cleave quality. For example, the investigators have observed fairly consistent cleave angle results for an abrasive coated wire contacting the fiber surface at an angle of about 8° to about 14°.

The shuttle device 150 includes one or more slots to allow clear passage of the optical fiber being cleaved prior to and during movement of the shuttle device. In the aspect of FIGS. 2A and 2B, shuttle device 150 includes a vertical fiber slot 155 and a horizontal fiber slot 156. Moreover, shuttle device 150 can include a base 153 configured to provide stability to the shuttle device 150 as it moves within the track 113 during the cleaving process. The shuttle can receive a finger pressing force to move the shuttle across the bare fiber portion 108 (see FIG. 1A) from a first (pre-cleaved) position (FIG. 1A) to a second position (FIG. 1B) during the cleaving process. In a preferred aspect, the shuttle device can be formed or molded from a polymer material or metal, while the flexible abrasive can preferably comprise an abrasive-coated metal wire 151. In another preferred aspect, the shuttle device 150 can be a disposable component that is replaced after some number of cleaves, for example after 10, 20, or 50 fiber cleaves.

In addition, the shuttle can be coupled to a bias spring 159 that biases against shuttle device 150 and helps return shuttle 150 to its pre-cleave or loading position. The shuttle bias spring 159 can provide a modest resistance against lateral travel to help reduce an accidental scoring of the optical fiber and an accidental release of the clamp plate 120. For example, FIG. 1A shows the shuttle 150 at an initial position appropriate for receiving an optical fiber prior to cleaving.

Cleaving of fiber 105 occurs when a flaw is introduced onto a stripped portion 108 of the fiber and the fiber experiences tension. In an exemplary aspect, the flaw can be introduced by a simple lateral movement of a (preferably) flexible, coated abrasive material, such as abrasive coated wire 151, across the stripped fiber surface. The flaw may be applied while the optical fiber is strained. In a preferred aspect, device 100 provides a substantially perpendicular cleave, within 0-4 degrees of perfect perpendicularity. Such perpendicularity is sufficient for eventual fiber polishing/finishing for field connector termination.

In operation, a cleaving process utilizing device 100 can take place as follows. A fiber to be cleaved is stripped using a conventional technique. The stripping can leave an exposed glass portion of the fiber. In one aspect, the exposed glass portion has a length of at least about 50 mm, more preferably from about 50 mm to about 60 mm. The fiber 105 can be inserted into the clamp system via a fiber entrance guide 111 disposed on an upper surface of main body 110, as is shown in FIG. 1A. The optical fiber can be inserted by itself, as is shown in FIG. 1A, or the fiber can be mounted on a fiber preparation tray (not shown) via a ramp structure 112 formed on main body 110. An exemplary fiber preparation tray is described in patent application Ser. No. 12/789984, incorporated by reference herein in its entirety. The entrance guide 111 is preferably configured to stop the buffer coating of fiber 105 from further insertion, while the stripped fiber portion 108 continues on and is inserted into the first clamp 130, shuttle device 150, and second clamp 140. In another aspect, the fiber entrance guide can accommodate more that one buffer coating thickness, such as a 900 μm buffer coated fiber and a 250 μm buffer coated fiber. A series of one or more fiber guides, as shown in FIG. 1A, fiber guides 139, 147a 147b, and 147c, can be formed before and/or after the clamp sections to help maintain proper fiber alignment during the insertion process.

In an alternative aspect, device 100 can be configured so that the axial distance between the first clamp 130 and the shuttle device 150, as well as the axial distance between the second clamp 140 and the shuttle device 150 is modified. In one alternative aspect, for some applications, the distance between the first and second clamps can be shortened. In this manner, the length of stripped fiber needed for clamping and cleaving can be reduced.

During insertion, the clamp plates 132 and 142 can be placed in their open positions, such as is shown in FIG. 1A. In addition, the shuttle device 150 is placed in its pre-cleave position (see FIG. 1A) so that the stripped portion 108 of optical fiber 105 can be inserted in the vertical fiber slot 155. The bare fiber portion 108 is placed in V-shaped grooves 135 and 145 (of clamps 130, 140) and can then be secured in position across both the first and second clamps 130 and 140. The first clamp 130 can be placed in the closed position by rotating plate 132 to press onto plate 134 and closing the first clamp with latch 138. Similarly, the second clamp 140 can be placed in the closed position by rotating plate 142 to press onto plate 144 and closing the second clamp with latch set 148a and 148b. In this aspect, the orientation of second clamp plate 142 provides that the remaining bare fiber 108 passes underneath the clamp plate 142 via fiber guide 147c. In some aspects the first clamp 130 can be secured prior to securing the second clamp 140 and in other aspects the second clamp 140 can be secured prior to securing the first clamp 130.

Following, the shuttle device 150 can be moved laterally across the main body so that the abrasive coated wire 151 contacts the outer surface of the bare fiber 108 to introduce a flaw in the surface. As shown in FIG. 3A, the lever 114 can then be released in the direction of arrow 116 so that the support 115 is disengaged from flap portion 120. With the clamped fiber bearing tension, the tension creates a fiber break at the flaw site suitable for subsequent field polishing and/or splicing or connectorization. This break is illustrated in FIG. 3B, where the flap portion 120 has moved downward, in the direction of arrow 117.

In an alternative aspect, the lever 114 can be released (placing the fiber under tension) prior to moving the abrasive coated wire 151 across a surface of the bare fiber 108 to introduce a flaw on the surface of the fiber.

When the fiber has been cleaved, it may be released from the clamps for subsequent field polishing and/or splicing or connectorization. The fiber shard can be disposed of using suitable safety precautions. In an alternative aspect, device 100 can also include a small shard disposal container formed on or attached to the main body 110.

Thus, a simple, compact, inexpensive cleaver can be utilized to create a cleaved optical fiber having a cleave angle of about 0° (±3.5°).

In addition to the embodiments described above, in a further alternative aspect, the device can further include a torsional strain mechanism to provide an additional, controlled torsional stress to the fiber being cleaved that would allow the user to create a non-perpendicular angle cleave. In this manner, controlled angle cleaves can be performed.

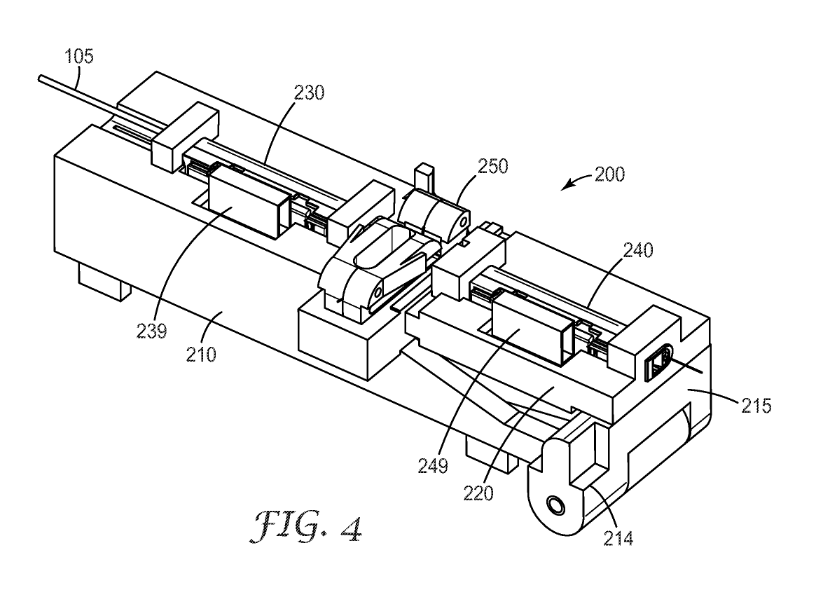

In a further alternative, such as shown in FIG. 4, a cleaver device 200 is provided. Cleaver device 200 is a bladeless, portable fiber cleaving device that provides suitable tension to permit cleaving of an optical fiber 105 through use of an abrasive material, such as a particle-coated filament, as opposed to a blade. Fiber cleaver 200 includes a generally planar main body 210 coupled to a generally planar, movable flap portion 220. The main body 210 and movable flap portion 220 can be movably coupled to each other, such as pivotably coupled or slidingly coupled, in a manner similar to device 100 described above. A lever 214 is coupled to support structure 215 that supports flap portion 220 prior to release of lever 214.

Device 200 further includes a first clamp 230 and a second clamp 240 to temporarily hold an optical fiber 105 in place prior to cleaving. These clamps 230, 240 are configured differently than the clamps utilized in device 100, in that clamps 230 and 240 each comprise a mechanical splice device, preferably a 3M™ FIBRLOK™ II mechanical fiber optic splice device, available from 3M Company, of Saint Paul, Minn. The operation of such a device is described in U.S. Pat. No. 5,159,653, incorporated herein by reference in its entirety. Although the 3M™ FIBRLOK™ II mechanical fiber optic splice devices are utilized to splice two fibers together, in this application, they can be utilized to grip the bare glass portion of fiber 105 in a manner that reduces torsional strains. As shown in FIG. 4, clamp 230 can be secured on its side to a top surface of main body 210 and clamp 240 can be secured on its side to a top surface of flap portion 220.

Each of clamps 230 and 240 include a fiber gripping element formed of a ductile material that includes a V-shaped groove. An actuating cap that is part of the 3M™ FIBRLOK™ II mechanical fiber optic splice device can be used to close the fiber gripping element and thus secure the bare glass portion of fiber 105. Plates 239 and 249 can be utilized by the field technician to easily actuate (by e.g., a simple pressing movement) the actuating caps of the first and second clamps 230, 240. The shuttle device 250 can be configured in a manner similar to shuttle device 150 described above. Care must be taken during multiple cleaves that the fiber clamps are cleared of possible debris that may inhibit fiber insertion. A release tool can be utilized to release the cleaved fiber and shard from the clamps 230, 240 after the cleaving process.

In a further alternative aspect, clamps 230 and 240 can comprise a different structure, such as a 3M™ FIBRLOK™ 4×4 mechanical fiber optic splice device, such as is described in U.S. Pat. No. 7,140,787, incorporated by reference herein in its entirety.

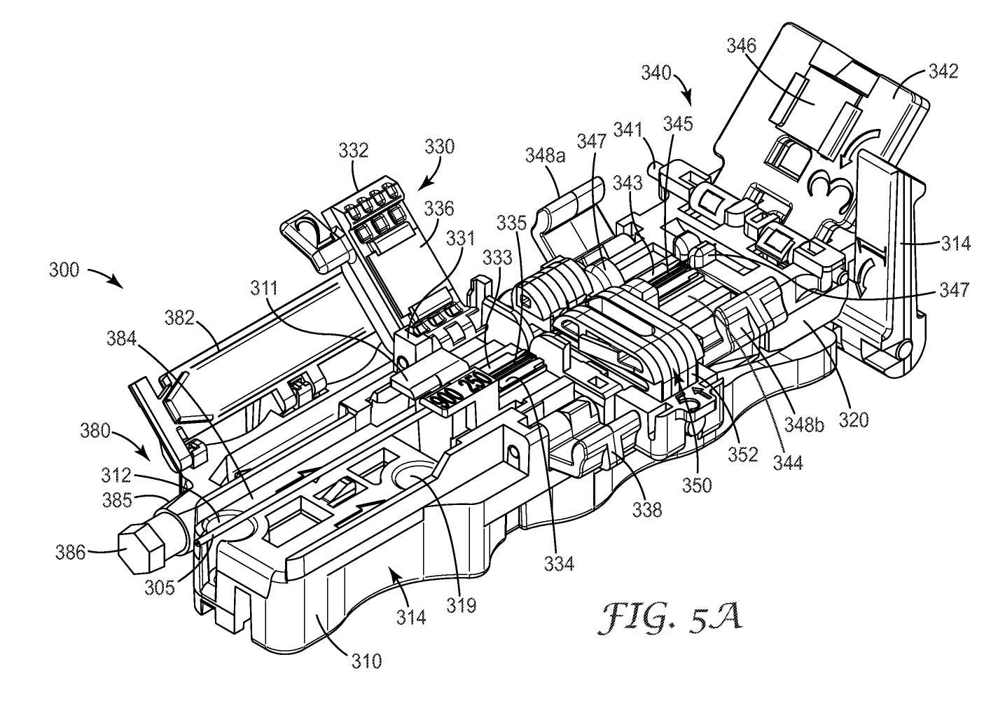

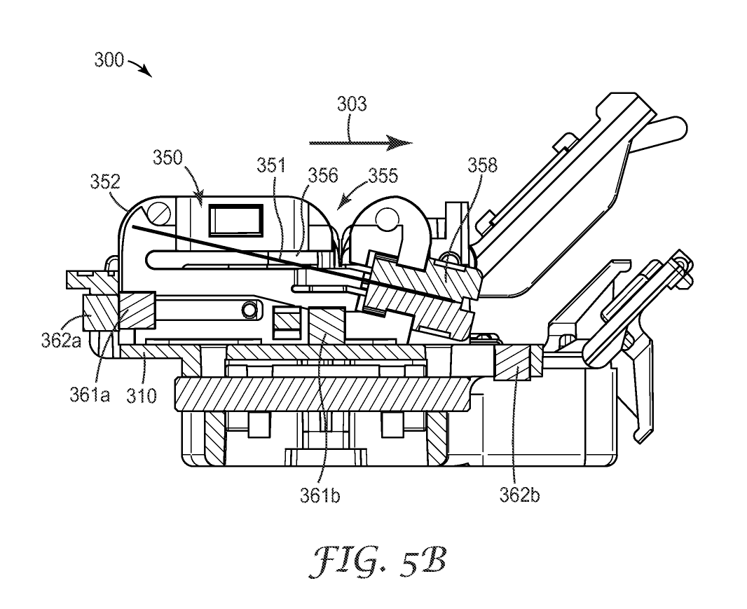

In a further alternative, such as shown in FIG. 5A, a cleaver device 300 is provided. Fiber cleaver 300 includes a generally planar main body 310 coupled to a generally planar, movable flap portion 320. Main body 310 and flap portion 320 are not required to be perfectly planar and may be configured to have some small separation or gap between them. The main body 310 and movable flap portion 320 can be movably coupled to each other, such as pivotably coupled or slidingly coupled, such as discussed above. In a preferred aspect, planar main body 310 and flap portion 320, and components thereof, can be formed or molded from a polymer material, such as a plastic, although metal and other suitably rigid materials can also be utilized.

Device 300 further includes a first clamp 330 and a second clamp 340 to temporarily hold an optical fiber 305 in place prior to cleaving. FIG. 5A shows clamps 330 and 340 in their open positions. A shuttle device 350 is disposed between the first and second clamps 330, 340. The shuttle device houses the abrasive material and is configured to slide laterally on the main body 310, in a direction substantially perpendicular to the fiber axis. The main body may include one or more indentations, such as scalloped-shaped indentations 314, to help the user better grip the device 300 with his or her fingers. In addition, the main body 310 may be provided with one or more through-holes 319 that will allow the device 300 to be secured to a table top or other working surface.

As shown in FIG. 5A, first clamp 330 is configured as a conventional plate-type clamp, having a movable (or upper) clamp plate 332 that is rotatable about shaft 331, which is aligned substantially parallel to the fiber axis. Plate 332 clamps onto bottom clamp plate 334, which is mounted onto or formed on main body 310. A latch 338 can be disposed on main body 310 opposite to shaft 331 and can be used to hold clamp 330 in a closed position during the cleaving process.

Clamp 330 is configured to clamp a stripped (bare) portion of fiber 305. In this manner, clamp 330 includes a bottom clamp plate insert 333 which includes a V-shaped groove 335, and is disposed on bottom clamp plate 334. The V-shaped groove 335 is configured to receive the bare portion of fiber 305 when the fiber is placed in clamp 130. In this exemplary aspect, the clamp plate insert 333 can be can be L-shaped, in that a portion of the clamp plate insert 333 can be secured within the bottom clamp plate 334 by inserting a portion of the clamp plate insert 333 into a pocket (not shown) formed in the bottom clamp plate 334. In this manner, the other portion of the clamp plate insert 333 having the V-shaped groove 335 is disposed on an upper surface of the bottom clamp plate 334 such that the bare portion of the fiber 305 can be received in the V-groove.

The bottom clamp plate insert 333 interacts with an upper clamp plate insert 336 when the first clamp 330 is placed in the closed position so that the upper clamp plate insert 336 contacts and presses onto the bare fiber portion received in groove 335. As with the embodiments described above, clamp plate inserts 333 and 336 can be formed from a ductile material, such as aluminum, which is a strong material, yet structurally weaker than the bare glass portion of fiber 305. In alternative aspects, the clamp plate inserts 133 and 136 can be formed from materials such as plastic, rubber, and steel.

As shown in FIG. 5A, device 300 includes a second clamp 340 disposed on flap portion 320. The second clamp 340 is configured as a plate-type clamp, having a movable (or upper) clamp plate 342. Clamp plate 342 is configured to rotate about a shaft 341 that is aligned substantially perpendicular to the fiber axis. Plate 342 clamps onto bottom clamp plate 344, which is mounted onto or formed on main body 310. This latch orientation helps reduce torsional stresses being placed on the fiber during the clamping process prior to cleaving. In addition, in a preferred aspect, providing a construction with zero clearance for the clamp plate 342 and shaft 341 can also reduce torsional stresses. A latch set 348a and 348b can be disposed on main body 310 on either side of clamp 340 and can be used to hold clamp 340 in a closed position during the cleaving process.

Clamp 340 is also configured to clamp a stripped (bare) portion of fiber 305. In this manner, clamp 340 includes a bottom clamp plate insert 343 which includes a V-shaped groove 345 disposed on bottom clamp plate 344. The V-shaped groove 345 is configured to receive the bare portion of fiber 305 when the fiber is placed in clamp 340. As with clamp 330 described above, the clamp plate insert 343 can be can be L-shaped, in that a portion of the clamp plate insert 343 can be secured within the bottom clamp plate 344 by inserting a portion of the clamp plate insert 343 into a pocket (not shown) formed in the bottom clamp plate 344.

The bottom clamp plate insert 343 interacts with an upper clamp plate insert 346 when the second clamp 340 is placed in the closed position so that the upper clamp plate insert 346 contacts and presses onto the bare fiber portion received in groove 345. In a preferred aspect, clamp plate inserts 343 and 346 are formed from a ductile material, such as aluminum, which is structurally weaker than the bare glass portion of fiber 305. In alternative aspects, the clamp plate inserts 343 and 346 can be formed from materials such as plastic, rubber, and steel.

The combination of the first and second clamps 330, 340, in particular the use of ductile inserts to clamp the bare portion of the optical fiber during cleaving, provides an anti-twist clamping system that can reduce fiber twisting or torque during the clamping and cleaving process.

Device 300 can further include a movable member, such as lever 314, hingedly coupled to main body 310 at one end of the body. As shown in FIG. 5A, lever 314 is positioned in a pre-cleave position and engages flap portion 320 to keep it in a planar orientation with main body 310. Lever 314 is coupled to support structure that supports flap portion 320 prior to release of lever 314. When the lever 314 is released, e.g., by rotating the lever 314, the lever/support disengages with body portion 320. A ridge or other structure may be formed on a surface of the lever 314 to prevent accidental or inadvertent disengagement of the lever 314 from the flap portion 320. Motion of flap portion 320 can be accomplished substantially via internal spring tension—for example, an elastic element such as a spring, e.g., a coil spring, such as is described above, can be coupled to body portion 310 and flap portion 320, pulling flap portion 320 downward relative to body portion 310. The spring tension can be used to create the tension forces described above.

In a further alternative aspect, the device 300 can include interlock features, such as a ratchet to engage a portion clamp plate 342 to prevent the closing of clamp plate 342/clamp 340 when the flap portion 320 and hinge 314 are not placed in their pre-cleave positions. This configuration can help prevent improper insertion of the fiber to be cleaved.

As mentioned above, device 300 further includes a shuttle device 350 disposed in a track (not shown in FIG. 5A, but similar to track 113 shown above) formed in the main body 310. The track is formed so that shuttle device 350 travels laterally on the main body, substantially perpendicular to the axis of fiber 305. A stop feature can be provided on device 300 to interact with the shuttle device 350 to ensure that shuttle device is not inadvertently removed from the track during or after a cleaving process.

The shuttle device 150 includes a body 352 that houses and holds an abrasive material used to introduce a flaw on the surface of fiber 305 during cleaving. In an exemplary aspect, the flaw may be introduced with a simple lateral movement of the abrasive material across the stripped fiber surface (e.g., in the direction of arrow 303—see FIG. 5B). The flaw may be applied while the fiber is strained in a controlled manner or alternatively, the flaw may be applied before the fiber is strained.

In a preferred aspect, the abrasive material comprises a flexible abrasive material, such as those described above, in particular, a filament having an abrasive material coated on an outer surface or portion thereof.

As shown in FIG. 5B, the abrasive material comprises an abrasive material coated filament 351 (also referred to herein as an abrasive coated wire 351). In another aspect, the abrasive coated wire 351 is coupled to an adjustment mechanism 358 mounted on an outer surface of the shuttle. The adjustment mechanism can be shaped as a simple rotatable knob. Alternatively, the abrasive coated wire can be mounted within the shuttle by a fastener (not shown), such as a mechanical device or an adhesive. This configuration provides for the wire 351 to be supported on one end, leaving the other end free, thus allowing it to flex freely as it comes into contact with the optical fiber during cleaving. In addition, the adjustment mechanism allows the user to change the contact area of the abrasive coated wire once a particular area of the coated wire is worn after repeated use. In addition, the abrasive coated wire can be set at an initial contact angle such that applying the abrasive coated wire 351 at a particular angle can reduce unwanted torsional or shear forces on the optical fiber, which could detrimentally impact cleave quality. For example, the investigators have observed fairly consistent cleave angle results for an abrasive coated wire contacting the fiber surface at an angle of about 8° to about 14°.

The shuttle device 350 includes one or more slots to allow clear passage of the optical fiber being cleaved prior to and during movement of the shuttle device. In the aspect of FIG. 5B, shuttle device 350 includes a vertical fiber slot 355 and a horizontal fiber slot 356. Moreover, shuttle device 350 can include a base configured to provide stability to the shuttle device 50 as it moves within the base track during the cleaving process. The shuttle can receive a finger pressing force to move the shuttle across the bare fiber portion from a first (pre-cleaved) position to a second position during the cleaving process. In another preferred aspect, the shuttle device 350 can be a disposable component that is replaced after some number of cleaves, for example after 10, 20, or 50 fiber cleaves.

In addition, in the embodiment of FIGS. 5A and 5B, movement of the shuttle 350 can be assisted via a magnet assembly. In this aspect, the magnet assembly includes one or more magnets disposed on or in the shuttle (as shown in FIG. 5B, magnets 361a and 361b are disposed in device 350) and one or more corresponding magnets disposed in base 310 (as shown in FIG. 5B, magnets 362a and 362b are disposed in base 310). In a first position, such as the pre-cleave position, magnet 361a can be coupled to magnet 362a. Upon placing a pressing force on the body 352 of shuttle 350, the shuttle 350 can be slid across the seated fiber, where magnet 361b would be attracted to magnet 362b until they are coupled via proximity or contact. The shuttle device can be returned to its pre-cleave or loading position by introducing a sliding force in the opposite direction.

Cleaving of fiber 305 occurs when a flaw is introduced onto a stripped portion of the fiber and the fiber experiences tension. In an exemplary aspect, the flaw can be introduced by a simple lateral movement of a (preferably) flexible, coated abrasive material, such as abrasive coated wire 351, across the stripped fiber surface. The flaw may be applied while the optical fiber is strained. In a preferred aspect, device 300 provides a substantially perpendicular cleave, within 0-4 degrees of perfect perpendicularity. Such perpendicularity is sufficient for eventual fiber polishing/finishing for field connector termination.

In addition, device 300 can further include a shard disposal container 380 formed as part of or integral with main body 310. The container 380 can be configured to temporarily store fiber shards created during cleaving until properly disposed of at a later time. In this exemplary aspect, shard disposal container 380 includes a well portion 384 having a cover 382 that may be opened or closed by the user to receive/store fiber shards. The shard disposal container 380 may further include an exit port 385 having a removable cap 386 that provides for disposal of the shards from the well portion 384 into a more permanent container or disposal unit.

Thus, the cleaver embodiments described herein can be utilized as a compact, low cost optical fiber cleaver suitable for field terminable connectors and splices and fusion splice devices. In particular, the cleaver embodiments herein utilize an anti-twist clamping system to reduce fiber twisting during the clamping and cleaving process.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

1. An optical fiber cleaver to cleave an optical fiber, comprising:
a generally planar main body;
a generally planar flap portion movable with respect to the main body;
a first clamp disposed on the main body to receive and hold a first bare glass portion of the optical fiber;
a second clamp disposed on the flap portion to receive and hold a second bare glass portion of the optical fiber; and
a shuttle device disposed on the main body axially between the first clamp and the second clamp and configured to move laterally with respect to an axis of the optical fiber, the shuttle device further including a flexible abrasive material configured to contact the optical fiber and create a flaw on an outer surface thereof during cleaving, wherein at least one of the first and second clamps is configured to hold the second bare glass portion of the optical fiber with substantially no twisting force.

2. The optical fiber cleaver of claim 1, wherein at least one of the first and second clamps includes a movable clamp plate configured to rotate about a shaft that is aligned substantially perpendicular to the axis of the optical fiber.

3. The optical fiber cleaver of claim 1, wherein the flexible abrasive material comprises an abrasive material coated wire.

4. The optical fiber cleaver of claim 3, further comprising:
a laterally disposed shaft coupling the main body to the flap portion at a first end of the flap portion;
a lever hingedly coupled to the main body and coupled to a support structure that supports a second end of the flap portion prior to cleaving; and
a spring coupled to the main body and the flap portion to provide a tension on the flap portion, wherein the flap portion is displaced from a substantially planar orientation with respect to the main body when the support structure is disengaged from the flap portion.

5. The optical fiber cleaver of claim 3, wherein each of the first and second clamps comprises:
a first clamp plate having an insert which includes a V-shaped groove disposed thereon configured to receive a bare portion of the optical fiber; and
a second clamp plate having an insert that presses onto the first clamp plate insert when the clamp is placed in a closed position.

6. The optical fiber cleaver of claim 5, wherein each of the clamp plate inserts is formed from a ductile material.

7. The optical fiber cleaver of claim 6, wherein the ductile material comprises aluminum.

8. The optical fiber cleaver of claim 1, wherein at least one of the first and second clamps includes a movable clamp plate configured to rotate about a shaft that is aligned substantially perpendicular to the axis of the optical fiber.

9. The optical fiber cleaver of claim 1, wherein the shuttle device includes an adjustment mechanism mounted thereon to adjust a position of the flexible abrasive material within the shuttle device.

10. The optical fiber cleaver of claim 4, wherein the spring places an axial strain onto the fiber of from about 180 grams to about 280 grams.

11. The optical fiber cleaver of claim 1, wherein at least one of the first and second clamps comprises a mechanical splice device.

12. The optical fiber cleaver of claim 1, further comprising a shard disposal container to temporarily store fiber shards created during cleaving.
